(19) United States
(12) Patent Application Publication
(10) Pub. No.: US 2006/0047673 A1
(43) Pub. Date: Mar. 2, 2006

(54) System and methods for controlling navigation area content via inline and dynamic search control

(76) Inventors: Mark E. Molander, Cary, NC (US); Gregory Richard Hintermeister, Rochester, MN (US); Velda Bartek, Apex, NC (US)

Correspondence Address: HARRINGTON & SMITH, LLP, 4 RESEARCH DRIVE, SHELTON, CT, 06484-6212, US

(21) Appl. No.: 10/927,870

(22) Filed: Aug. 27, 2004

(51) Int. Cl. G06F 7/00

(52) U.S. Cl. 707/101

(57) ABSTRACT

A system in accordance with the present invention provides an improved console navigation area for managing multiple folders and applications. In particular, the present invention permits a user to create logical relationships among computer objects inline and dynamically within a navigation area, e.g., files, folders or application using search and filtering tools and to save them for later recall. The user specifies a name describing the search or filter results, and the search or filter results can be saved as a discrete entry in an easy to access selectable list. In other embodiments, the system of the present invention permits a user to collect a number of actions available in multiple application programs and save them under a unique name.

### TECHNICAL FIELD

The present invention concerns graphical user interface systems for enabling computer users to manage multiple application programs and system resources, and more particularly concerns searching and filtering methods and apparatus for use in managing multiple integrated applications.

### BACKGROUND

The present invention concerns computer user interfaces, wherein the user interfaces are used to manage multiple tasks, files, folders or other computer system resources. Currently, efforts are being made to manage multiple application programs or system resources through an integrated user interface. These efforts have encountered a number of problems.

For example, the folder systems encountered in typical operating systems are very limited in their ability to create logical relationships among pre-existing system resources, e.g., files. For example, assume that a user desires to collect all files associated with a task, and that the files are scattered throughout a plurality of unrelated folders. There is no simple way in accordance with the prior art to create and save a logical relationship among files. First, the user has to locate the documents. Typically this is accomplished by using a file search utility. After related documents have been located with the search utility, the user collects them into a new folder so that they may be accessed at a later time. This requires the user to create a new folder and copy the documents to the new folder.

The described procedure is cumbersome and has several negative consequences. First, the procedure itself requires many keystrokes or mouse actions to collect the related documents into a single folder. Second, the file structure adopted for a managing a task may be disturbed if the user creates a new folder for storing active documents. Third, copy proliferation typically occurs; the user now has multiple copies of documents.

In more complex situations comprising multiple-application-program work environments the problems become even more difficult. In particular, those skilled in the art desire application integration, wherein the functionality of multiple application programs is accessible from a single user interface, which is often referred to as a console. Such consoles typically comprise at least two primary areas, a right-side content area to present application or folder content, and a left-side navigation area for the user to launch or navigate to the content. Maturing and currently-known task environments may result in very crowded navigation areas that are overpopulated with actions, folders or other resources and nodes.

For example, the most commonly encountered user interface is associated with windows-type operating systems. Although the windows-type desktop feature provides a common work area from which to launch multiple application programs, there is no further integration of application program interfaces. In typical task situations, a user switches among multiple user interfaces by minimizing and maximizing applications from the taskbar. There is no simple way to combine into a single user interface program actions selected from multiple application programs. For example, a multimedia developer may concurrently use several application programs to create content. In so doing, the multimedia developer uses only a fraction of the actions available in the application programs. Further, the multimedia developer frequently switches back and forth among files, folders and application programs.

In situations in accordance with the prior art where application programs are poorly integrated, the multimedia user will be constantly switching between various application programs, e.g., by maximizing the graphical interface of an application when using it, and then minimizing the application when momentarily finished with the application. Further, when interacting with a user interface associated with a given application program, the multimedia user typically is confronted by more toolbars, taskbars, work areas, etc. then needed to perform a task. Taken together, these limitations result in inefficiency as users must spend time switching between applications, and figuring which application program actions to select from a typically complicated and crowded user interface.

Thus, a significant problem encountered at the user interface (“UI”) level concerns how to make the navigation area, which launches and surfaces the tasks and primary panels, scale from single applications to multiple integrated applications. If a navigation area displayed in the UI is optimally populated for a single application, it can become quickly over-populated with the display of additional applications. Alternatively, in navigation areas for applications having relatively few launch points because of concern that a user may integrate the portfolio with other applications, the user may suffer from a sub-optimal and sparse navigation area.

As a result, those skilled in the art desire a user interface management tool that permits users to dynamically integrate system resources and application program actions in a way that simplifies tasks by permitting users to combine resources and application actions into a single streamlined access point.

Further problems have been encountered in systems made in accordance with the prior art. For example, the multimedia user of the preceding example in doing her work may typically encounter a finite set of tasks that require very specific, but different combinations of application program actions and task environments. Although it would be advantageous to have tools to customize the user interface so that application actions and resources can be combined into an integrated user interface console, it would be tedious to have to recreate the custom environment from the beginning each time the multimedia user turns to a task that requires a custom work environment that the developer has previously used.

In addition, the desired work environment may involve only a relatively small modification to a known work environment to achieve the “ideal” work environment. Without a facility to store known work environments for future recall, there would be no efficiency gain associated with making a small modification to a pre-existing work environment since each work environment will have to be recreated from scratch. This is fraught with difficulty since it may be difficult to merely recall the starting combination of application actions and resources that will modified by the user to create another custom work environment.

Other problems associated with poorly integrated resources and application programs are also encountered in the art. In the preceding example the multimedia user uses multiple application programs to create a single multimedia product. The multimedia user of this example is task-oriented and is particularly concerned with what effects may be achieved with various application programs. In contrast to a task perspective, there are system administrators who are mainly concerned with preserving and managing resources. Although the system administrator naturally performs tasks to maintain a resource, the system administrator thinks “resource first, task second”.

In systems in accordance with the prior art, there is no practical way to organize a work environment from a resource perspective. In other words, in systems operating in accordance with the prior art, the system administrator has to access an application program first, and then, after having entered the work environment of the application program, specify the resource to be acted upon.

This “task-first” approach to organizing a graphical work environment has easily conceivable negative consequences. For example, if the system administrator has to perform several tasks with different application programs on a single resource, the system administrator would rather organize her work environment in an hierarchical manner by resource first, and then task, wherein the tasks to be performed may be performed by separate application programs.

In addition, assuming the availability of a user interface management system that would allow a user to create a user interface to manage multiple resources, one of ordinary skill in the art would naturally desire some way to save the custom work environment reflecting a resource-first perspective so that it may be recalled at a future time, or applied to a different resource which nonetheless is managed using the same actions available in an application program.

Thus, those skilled in the art desire graphical user interfaces that provide significant advantages over the prior art. In particular, those skilled in the art desire methods and apparatus for logically relating files, folders, applications or other computer-related objects, and saving this logical relation for future access. Further, those skilled in the art desire graphical front ends that integrate the functionality of numerous application programs, but with the advantage that the actions or tasks that can be performed by applications can be grouped in a user-specifiable manner.

### SUMMARY OF THE PREFERRED EMBODIMENTS

The foregoing and other problems are overcome, and other advantages are realized, in accordance with the following embodiments of the present invention. The present invention comprises a system having a console comprising a drop-down menu for describing and choosing available resources; an inline search tool accessible through a search icon; and an inline filtering tool accessible through a filter icon. In embodiments of the present invention, users create logical relationships between, e.g., files, folders, or volumes using the search or filter tools and save the logical relationships created with the search or filter tools under a unique name to the drop down menu.

In a first alternate embodiment, the present invention comprises an inline search tool integrated in a console made in accordance with the present invention. The search tool permits the user to search and collect files, folders, volumes or application actions that meet user-specified criteria. Search results are displayed in the navigation area in dependence on the user-specified criteria. This embodiment further provides a naming system that permits the user to assign a unique name to the search criteria specified by the user. The naming system also permits the user to assign a node in the drop-down menu structure where the named search criteria may be retrieved.

Other variants of the first alternate embodiment of the present invention provide an inline sort function that operates in cooperation with the search function. This permits the user to pre-sort according to a user-specifiable criteria results from the search function. In embodiments of the present invention, the sort criteria may comprise task criteria, where nodes in the navigation area are organized according to actions that might be performed on them by actions available in an application program or programs. In another embodiment of the present invention, the sort criteria may comprise system criteria wherein available volumes are sorted by the system on which each volume respectively resides.

In further variants of the first alternate embodiment of the present invention, the search function operates on a set of keywords added by an application program, application program action, file, folder, volume or other computer system resource when that application program, application program action, file, folder volume or other computer system resource is added to a node in the navigation area. Additionally, a user can specify keywords herself to describe application programs, application program actions, files, folders, volumes or other computer system resources available to the user. The search function then operates on the keywords. The keywords can be used to synonymously describe computer system resources so that a natural language search would be more likely to locate a desired object. In further variations, the keywords can be used to describe various application program actions available to a user in a feature-rich application program, thus allowing a user to search on a very fine basis among application program actions.

In a second alternate embodiment of the present invention, a filter system is integrated in the console of a graphical user interface made in accordance with the present invention. The filter function is implemented through an inline drop-down dialogue box that allows the user to specify filter criteria. In one variant made in accordance with the second alternate embodiment of the present invention, the filter system dialogue box comprises a filter box which permits the user to specify the desired filter, type and character string. In this example, the user would filter folders by whether individual folders contained a particular character string. In the filter dialogue box, the user would specify “include”; in the type dialogue box the user would specify type; and in the character string dialogue box, the user would specify the character string. In further variants of the second alternate embodiment, the present invention provides a name and save feature that permits the user to assign a unique name to the filter criteria specified by the user, and to save the filter criteria for later access.

In further variants of the second alternate embodiment of the present invention, the filter function operates on a set of keywords added by an application program, application program action, file, folder, volume or other computer system resource when that application program, application program action, file, folder volume or other computer system resource is added to a node in the navigation area. Additionally, a user can specify keywords herself to describe application programs, application program actions, files, folders, volumes or other computer system resources available to the user. The filter function then operates on the keywords. The keywords can be used to synonymously describe computer system resources so that a natural language search would be more likely to locate a desired object. In further variations, the keywords can be used to describe various application program actions available to a user in a feature-rich application program, thus allowing a user to filter on a very fine basis among application program actions.

A third alternate embodiment of the present invention comprises a method for use in a computer system for creating logical relationships among files, folders, volumes, application programs, application program actions or other system resources. The method comprises accessing a navigation area of a console from a graphical user interface of the computer system, wherein the navigation area comprises a tree list for displaying system nodes and a tool bar for specifying actions that can be performed on the system nodes, wherein the actions specify logical relationships between or among system nodes; and specifying an action using the tool bar, wherein when the computer system performs the action, the computer system will display system objects in accordance with a criterion specified in the action.

In another variant of the third alternate embodiment of the present invention, the method comprises the additional step of naming the criterion specified in the action selected by the user using the tool bar, by accessing a naming facility integrated in the navigation area of the console.

In yet another variant of the third alternate embodiment of the present invention, the method comprises the further step of saving the name selected by the user using the tool bar in a user-specified location in the tree list, wherein an action corresponding to the criterion named by the user can be accessed at a later time to operate on computer system objects.

In a still further variant of the third alternate embodiment of the present invention, the method comprises the further steps of accessing at a later time the tree list displayed in the portfolio console of the computer system; searching the tree list for the name corresponding to the criterion contained in the action specified by the user using the tool bar of the portfolio console; and selecting the name, wherein by selecting the name the computer system again applies the criterion contained in the action originally specified by the user using the tool bar.

Thus embodiments made in accordance with the present invention overcome the limitations of the prior art. In particular, the present invention permits a user to create logical relations among nodes in a tree of a navigation area, e.g., files, folders, volumes, or application actions, using a search or filtering function, and to save the logical relation for future access. This provides users with a powerful inline tool for organizing such files, folders, objects or application actions in ways that streamline the work process. Instead of being overwhelmed by situations where the user's console is over-populated with system assets not currently being worked on or used, the user can specify a meaningful and logical relation among system resources that provides a streamlined and efficient working environment, and save that logical relation for future access.

In addition, in situations where a console made in accordance with the present invention is being used to manage application actions available in multiple application programs, the present invention permits a user to organize the available application program actions in ways that best suit the work at hand. In particular, in situations where only a subset of application program actions are needed to perform a specific task, a user can select only those application program actions that are of interest using the search or filtering tools of the present invention, and save that subset under a unique name. Thus, when a user is confronted by another task requiring the same subset of available application program actions, the user can recognize the required subset of application program actions by selecting the unique name assigned previously.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a navigation area control within a console having portfolio selector, filter and search controls made in accordance with a first alternate embodiment of the present invention;

FIG. 2 depicts a navigation area control within a console having portfolio selector, filter and search controls; and which displays operation of the search control all made in accordance with a first alternate embodiment of the present invention;

FIG. 3 depicts a navigation area control within a console having portfolio selector, filter and search controls; and which displays the operation of the search control using an alternate search criterion from that depicted in FIG. 2, all made in accordance with a first alternate embodiment of the present invention;

FIG. 4 depicts a navigation area control within a console having portfolio selector, filter and search controls; and which displays the operation of the filter control, all in accordance with a second alternate embodiment of the present invention;

FIG. 5 depicts a navigation area control within a console having portfolio selector, filter and search controls; and which displays the operation of the filter control using an alternate filter criterion all in accordance with a second alternate embodiment of the present invention; and

FIG. 6 depicts a block diagram depicting a method operating in accordance with a third alternate embodiment of the present invention.

### DETAILED DESCRIPTION OF THE PREFERRED EMBODIMENTS

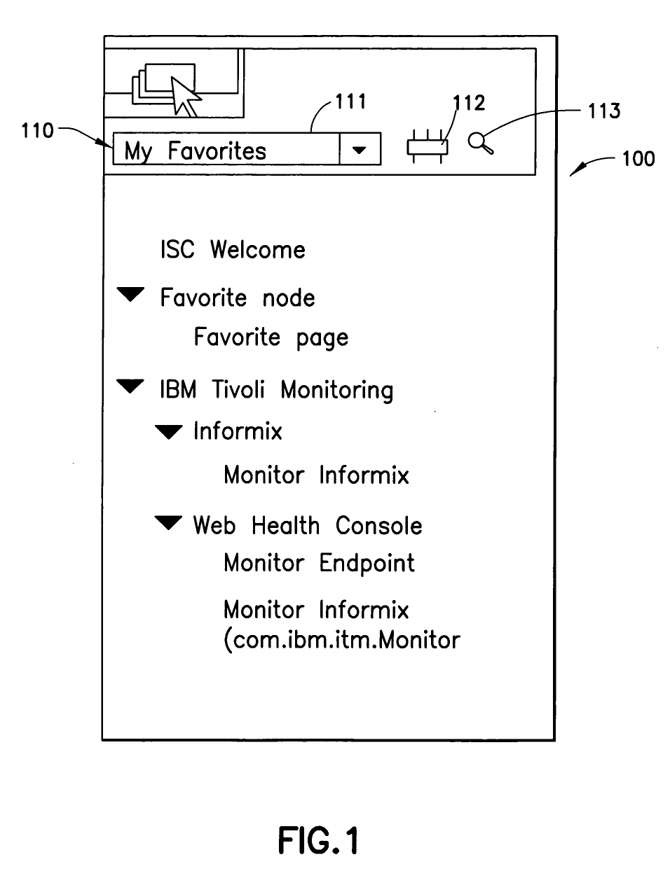

A first alternate embodiment of the present invention is depicted in FIG. 1. In FIG. 1, the navigation area 100 is shown with the high-level navigation area content controls in the second bar 110 from the top of the navigation area. From left to right in this bar 110 is a portfolio selector drop-down list 111; an inline filter icon 112 and an inline search icon 113. The filter 112 and search 113 icons are currently not selected and not opened. The navigation area depicts a portion of a graphical user interface implemented in a computer system. The apparatus and methods of the present invention are implemented in a signal bearing medium, e.g., a computer system, tangibly embodying a program of machine-readable instructions executable by a digital processing apparatus associated with the computer system to perform operations in accordance with the present invention.

The portfolio selector drop-down list 111 illustrates particular limitations of the prior art because the user is presented with predetermined navigation area content portfolio categories which do not permit the user to dynamically customize the portfolio categories according to various search and filter criteria. The addition of filter and search systems and methods made in accordance with the present invention provides improved capability for users to customize their task environments by creating logical relations among the nodes of the portfolio, e.g., files, folders, volumes, application programs, application program actions and other computer system resources using the filter and search features.

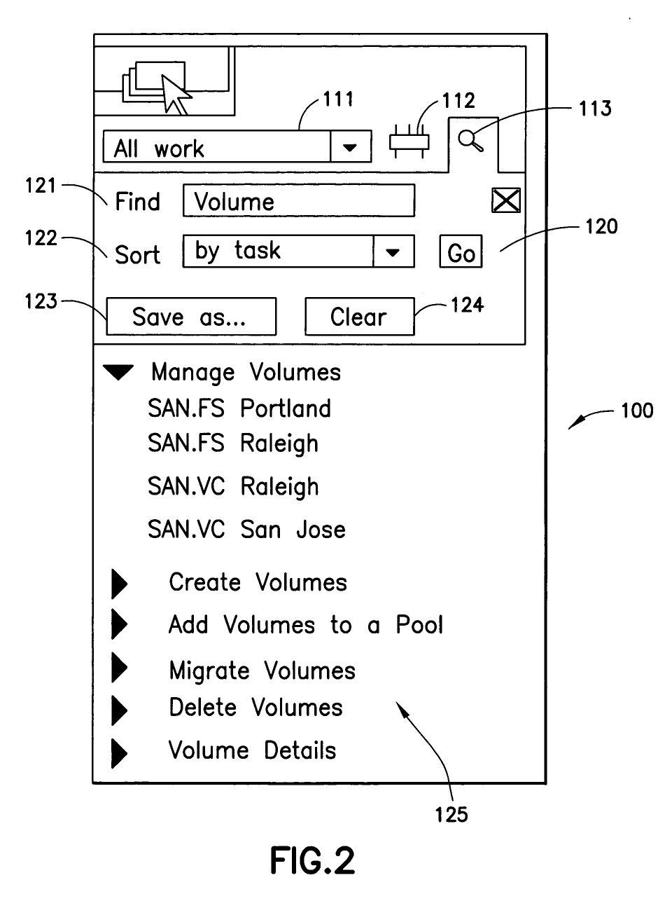

In FIG. 2, the operation of the search facility is depicted. A user accesses the search facility by clicking the search button icon 113 in the top bar 110 to open an inline dialogue box 120 to allow the user to do a dynamic search. The items to be searched are specified in the find entry field 121. In addition to the search capability, a sort control 122 is also provided. Common sorts are by task; resource; system; volume; domain; application program action, etc.

In addition, the save feature of the present invention is depicted in FIG. 2. The save feature is accessed by selecting the “save as” button 123. The “save as” button 123 permits the user to assign a unique and user-specified name to the search criterion created using the search and sort features of the present invention. Once named, the search criterion corresponding to the name will be displayed in the drop-down list 125 for easy selection later.

A “clear” button 124 is also provided in the search dialogue box 120. The clear button 124 allows a user to clear the current search criteria so that new search criteria may be specified.

These features illustrate a powerful aspect of the present invention. In particular, once the desired combination of navigation tree nodes, e.g., files, folders, volumes, application programs, or application program actions are created using the search and sort features of the present invention, the user can save them. Once saved, the combination as a portfolio is available for future access. Thus, a computer user need not use the cumbersome features of current operating systems and consoles to create logical relationships among computer resources.

Further, the combination of system resources and application program actions into a single node in the drop-down list is especially powerful; the user need not enter the task environment of an application program to perform an action on a file, folder or other system resource; in methods and systems operating in accordance with the present invention, the user need merely select the desired node in the navigation tree 125 to perform an application program action on a system resource.

In another application of the present invention, a user can organize specific search engine queries as application program actions and save them under user-specified names. Thus, the user need not access the user interface of the search engine and re-specify search criteria each time the user desires to perform a particular search. Such flexibility provides significant efficiencies to users of interface systems operating in accordance with the present invention.

In further variants of the embodiments depicted in FIG. 2, there is an associated keyword system that further improves the search functionality of the invention. In particular, associated with each application program, application program action, file, folder, volume or other computer system resource used in conjunction with the search feature of the present invention there are a set of keywords used to describe features or aspects of each application program, application program action, file, folder, volume or other computer system resource. When an application program, application program action, file, folder, volume or other computer system resource is added to a node in the navigation tree 125, the keywords associated with that application program, application program action, file, folder, volume or other system resource become operative. This means that searches will search not only file names, application program action names, etc., but also the keywords associated with the computer 'system resource. A particular strength of the keyword system is that it can be used to synonymously describe objects so that a natural language search would be more likely to locate a computer system resource. A further strength of the keyword system is that it can be used to describe with high degree of particularity the application program actions available in a feature-rich application program.

In additional variations of the first alternate embodiment, there is provided a system for allowing a user to create keywords herself to associate with an application program, application program action, file, folder, volume, or other computer system resource.

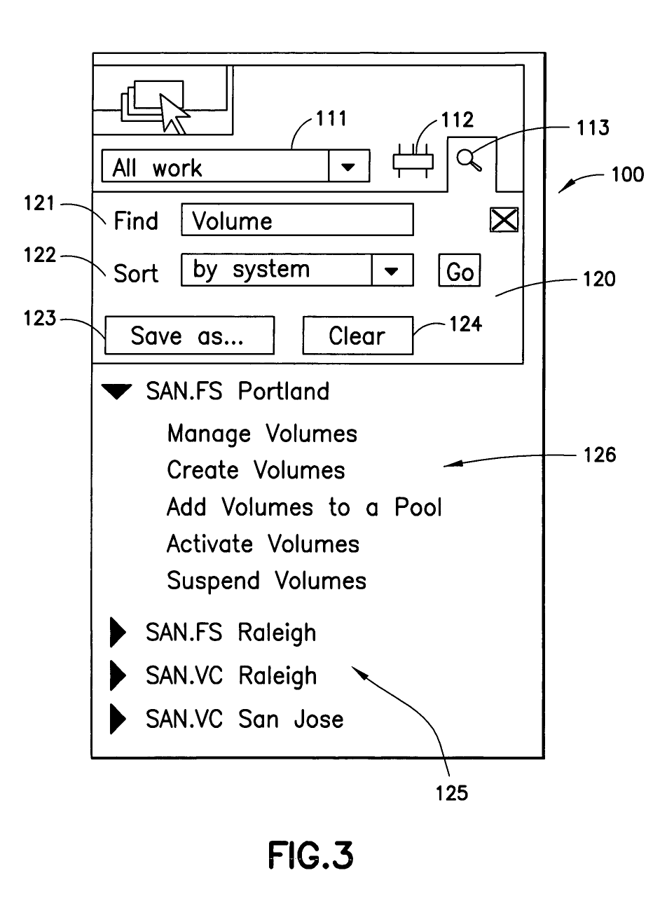

Further advantages of the present invention are depicted in FIG. 3. In contrast to the task organization of resources depicted in FIG. 2, in FIG. 3 the user has selected find and sort criteria to organize objects by resource first. In this example, the user accessed the navigation area 100, and specified the navigation tree nodes to be surfaced by specifying “volume” in the find entry field 121. In order to accomplish a resource organization of the volumes, the user specified in the sort drop-down list 122 the sort criterion “by system”. As illustrated in FIG. 3, after the “search” action has been performed by the computer system, the available volumes have all been located, and have been sorted by system as depicted in the navigation tree 125. As shown in the navigation tree application program actions are still available to the user, except they are available on a system basis.

It is an aspect of the present invention that the application program actions illustrated in the listing 126, e.g., “manage volumes”, need not be application program actions from a single application program. Rather, the actions depicted may be selected from several or more application programs. This is another powerful feature of the present invention. Assume the user in FIG. 3 is a system administrator who typically approaches resource administration from a resource perspective first, and then by task. In the resource management environment created using the systems and methods of the present invention depicted in FIG. 3, the system administrator can approach resource administration from the desired resource perspective. The system administrator selects the resource to be administered by selecting the desired node. Then the system administrator selects the application program action to be performed on the system resource by selecting the desired task from the list 126.

In systems operating in accordance with the prior art, there is no practical way to approach resource administration from this resource-first perspective. Thus, if a system administrator has to perform a series of management actions on a system resource, the administrator would have to run each application program successively, keeping track independently of the actions performed and the resource acted upon. In the task environment depicted in FIG. 3 the resource being managed is already specified by selecting the desired node in the navigation tree 125. This permits the user to quickly perform a series of management tasks on a single resource without having to continually re-specify the system resource as each application program is accessed.

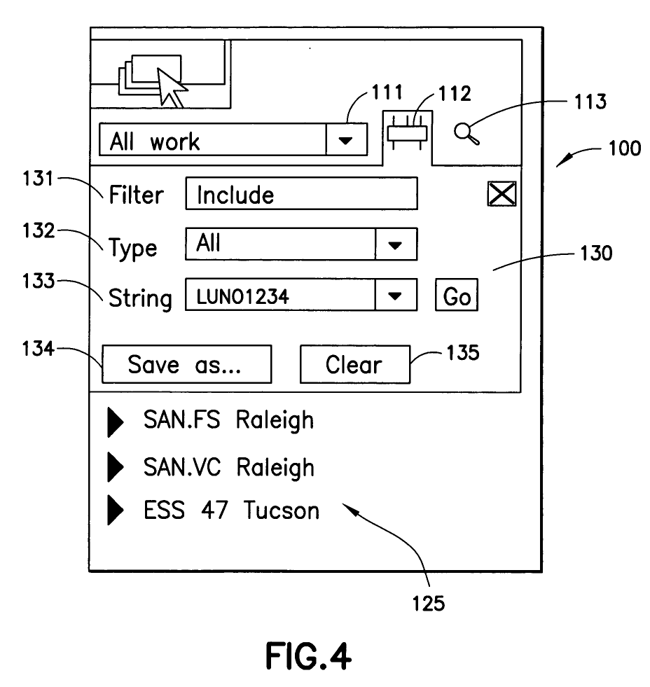

A second alternate embodiment of the present invention, and methods in accord with further embodiments of the present invention, are depicted in FIG. 4, which illustrates how the filter feature of the present invention operates. A user accesses the filter feature of the present invention by selecting the filter icon 112. The inline filter dialogue box 130 is then displayed by the computer system. As depicted in FIG. 4, there are three additional controls which together comprise the inline filter feature of the present invention. The filter feature comprises a filter operator drop-down list 131; a filter type drop-down list 132; and a character string entry field 133. As illustrated in FIG. 4, the user has filtered the entries depicted in the navigation tree 125 by the combination of filter criteria specified in the filter operator 131; type 132 and character string control 133 to find and include only the system resources that contain the character string. The filter results are then displayed in the navigation tree 125.

In another variant of the second alternate embodiment the user can save the filter criteria specified by the entries in the filter operator 131, type 132 and character string 133 controls by accessing the save feature through the “save as” 134 button. With this feature, the user can assign a unique name to the combination of filter criteria specified with the filter operator 131; type 132 and character string 133 controls. This provides another powerful feature of the present invention in that a user need not re-create a specific filtering criteria each time the user desires to filter the navigation tree nodes, e.g., files, folders, application programs, application program actions or other system resources; the user need only access the unique name assigned to the filter criteria to perform again the filtering action.

The filter dialogue box 130 also contains a “clear” button 135 for allowing a user to clear the filter criteria.

In this particular example, operator 131, type 132 and character string 133 filter criteria are illustrated, but other combinations of filter criteria may be specified, all within the scope of the present invention.

Similar to the first alternate embodiment, the filter feature of the present invention can operate on an associated keyword system. In one variant, application programs, application program actions, files, folders, volumes or other computer system resources would have associated predetermined keywords describing various aspects and features. The filter function of the second alternate embodiment would then operate on these keywords. In other variants, a user would have the ability to select keywords herself to describe features and aspects of application programs, application program actions, files, folders, volumes or other computer system resources.

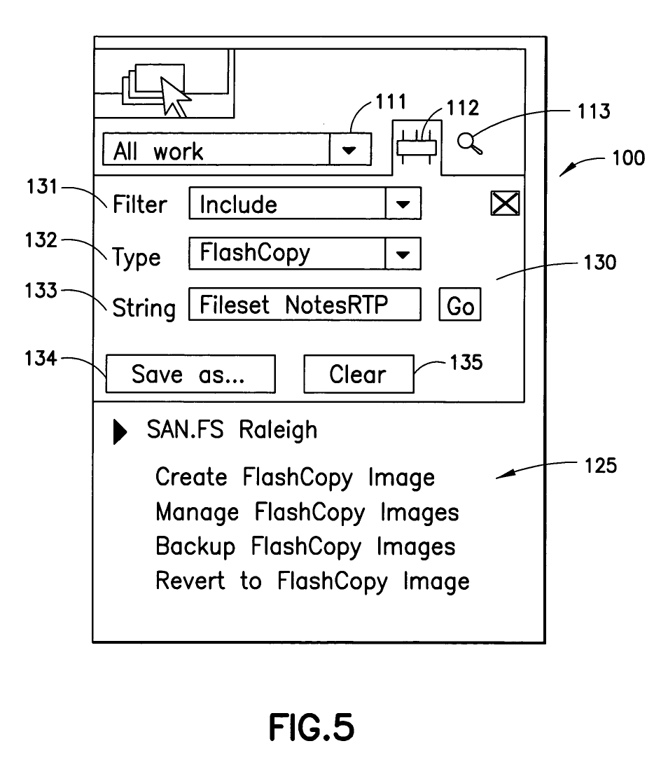

Another aspect of the second alternate embodiment of the present invention is depicted in FIG. 5. In this example, the filter feature is used to display only nodes relating to an application program action that contains a specific string. The user specifies the filter using the filter operator 131; type 132 and character string 133 controls to display the filtered nodes. As illustrated in FIG. 5, the character string filter was applied deeper than the navigation tree node labels. The navigation tree was filtered by the computer system to find instances that meaningfully matched the character string criteria specified with the character string entry field.

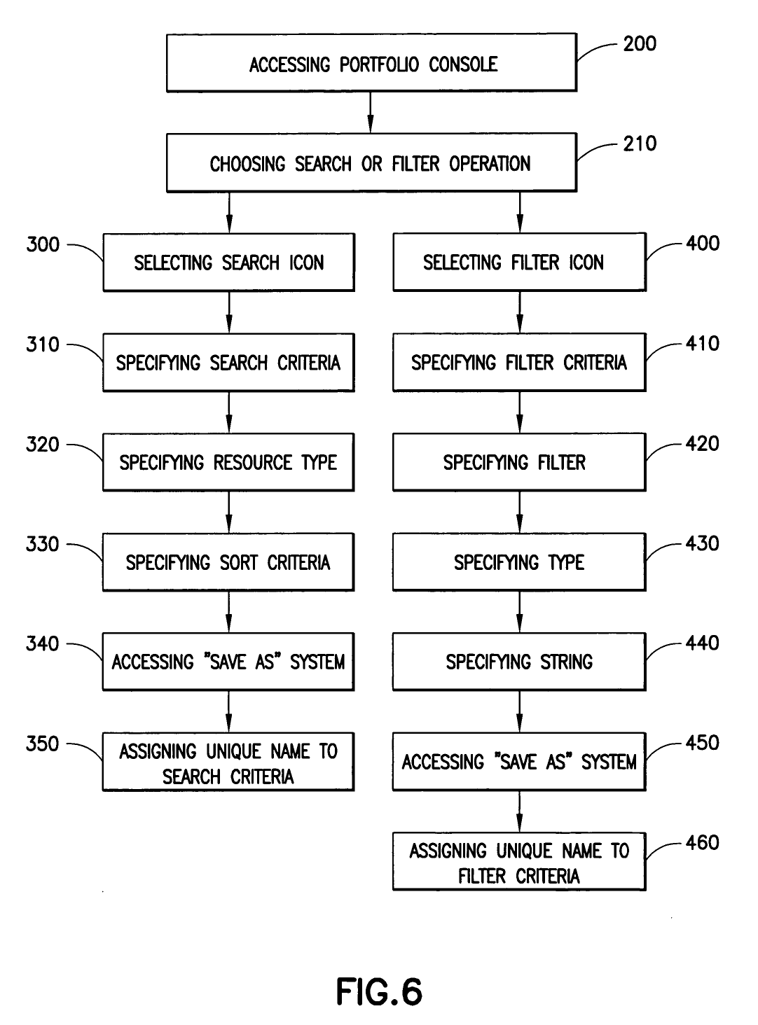

A method in accordance with a third alternate embodiment of the present invention is depicted in FIG. 6. In the method of the third alternate embodiment, the user accesses a navigation area 100 made in accordance with the first or second alternate embodiments at step 200. The user then decides whether the desired organizational operation is best performed by a search operation or filtering operation at step 210.

If the user decides that the task environment organization is best achieved using the search feature of the present invention, the user accesses the search dialogue box 120 by selecting search icon 113 at step 300. The user then specifies the search criteria at step 310 by specifying the system resources to be located by entering a selection in the find entry field 121 at step 320, and then by entering a sort criterion in the sort drop-down list 122 at step 330. If the user desires to save the search results for future access, the user selects the “save as” button 123, and assigns a unique name to the search criteria reflected in the find field 121 and the drop-down 122 at steps 340 and 350.

If the user decides that task organization is best achieved using the filtering feature of the present invention, the user selects the filter feature through icon 112 at step 400. The user then selects the filter criteria at step 410 by completing the filter 131, type 132 and character string 133 controls at steps 420; 430 and 440, respectively. If the user desires to save the filter results for future access, the user selects the “save as” button 134, and assigns a unique name to the filter criteria reflected in the filter 131, type 132 and character string controls at steps 450 and 460.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent portfolio console user interfaces with dynamic search and filtering capability may be attempted by those skilled in the art. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

We claim:

1. A signal bearing medium tangibly embodying a program of machine-readable instructions executable by a digital processing apparatus of a computer system to perform operations to display a user interface control system, the operations comprising:
displaying an inline and dynamic navigation dialogue box, the inline and dynamic navigation dialogue box comprising:
a navigation tree module to display a selectable drop-down portfolio navigation tree comprised of a plurality of nodes;
a filter function to filter one or more of the plurality of nodes of the navigation tree; and
a search function to search one or more of the plurality of nodes of the navigation tree.

2. The signal bearing medium of claim 1 wherein the filter function filters navigation tree nodes by name.

3. The signal bearing medium of claim 1 wherein the filter function filters navigation tree nodes by date.

4. The signal bearing medium of claim 1 wherein the filter function filters navigation tree nodes by contents.

5. The signal bearing medium of claim 1 wherein the filter function filters navigation tree nodes by domain.

6. The signal bearing medium of claim 1 wherein the filter function filters navigation tree nodes by application.

7. The signal bearing medium of claim 1 wherein the filter function filters navigation tree nodes by file type.

8. The signal bearing medium of claim 1 further comprising:
a filter result saving module to save the filtered file results as an entry in the drop-down portfolio navigation tree.

9. The signal bearing medium of claim 8 further comprising:
a naming module to enable a user to assign a name to the filtered file results to be displayed in the drop-down portfolio navigation tree.

10. The signal bearing medium of claim 1 wherein the search function searches the contents of items.

11. The signal bearing medium of claim 1 wherein the search function comprises:
a find control specifying the type of item that is the subject of the search; and
a sort control specifying the sorting criteria to be applied by the search function.

12. The signal bearing medium of claim 11 wherein the sort control specifies task as a sort criterion.

13. The signal bearing medium of claim 11 wherein the sort control specifies system as a sort criterion.

14. The signal bearing medium of claim 11 wherein the sort control specifies application action as a sort criterion.

15. The signal bearing medium of claim 1 further comprising:
a search result saving system for saving the search results as an entry in the drop-down portfolio navigation tree.

16. The signal bearing medium of claim 15 further comprising:
a naming system for permitting a user to assign a name to the search results to be displayed in the drop-down portfolio navigation tree.

17. The signal bearing medium of claim 1 wherein the one or more nodes of the navigation tree correspond to one or more computer system resources, and wherein the inline and dynamic navigation dialogue box of claim 1 further comprises:
a keyword system for describing aspects and features of the computer system resources using keywords, wherein the filter and search system operate on the keywords.

18. The signal bearing medium of claim 17, wherein the computer system resource is an application program action.

19. A user interface control system method comprising:
displaying an inline and dynamic navigation dialogue box, the inline and dynamic navigation dialogue box comprising:
a navigation tree region to display a selectable drop-down portfolio navigation tree comprised of a plurality of nodes;
a filter function to filter at least one of the plurality of nodes of the navigation tree; and
a search function to search at least one of the plurality of nodes of the navigation tree.

20. The user interface control system method of claim 19 further comprising:
filtering the plurality of nodes using a filter specified using the filter function.

21. The user interface control system method of claim 20 wherein:
the inline and dynamic navigation dialogue box further comprises:
a naming function to assign a unique name to filter criterion specified using the filter function; and
wherein the user interface and control system method further comprises:
assigning a unique name to filter criterion using the naming function.

22. The user interface control system method of claim 21 wherein:
the inline and dynamic navigation dialogue box further comprises:
a saving function to save the unique name assigned to filter criterion to the selectable drop-down portfolio navigation tree; and
wherein the user interface and control system method further comprises:
saving the unique name to the selectable drop-down portfolio navigation tree.

23. The user interface control system method of claim 22 further comprising:
selecting the unique name saved in the selectable drop-down portfolio navigation tree; and
applying the filter criterion corresponding to the unique name.

24. The user interface control system method of claim 19 further comprising:
searching the plurality of nodes using a search specified using the search function.

25. The user interface control system method of claim 24 wherein:
the inline and dynamic navigation dialogue box further comprises:
a naming function to assign a unique name to search criterion specified using the search function; and
wherein the user interface and control system method further comprises:
assigning a unique name to search criterion using the naming function.

26. The user interface control system method of claim 25 wherein:
the inline and dynamic navigation dialogue box further comprises:
a saving function to save the unique name assigned to search criterion to the selectable drop-down portfolio navigation tree; and
wherein the user interface and control system method further comprises:
saving the unique name to the selectable drop-down portfolio navigation tree.

27. The user interface control system method of claim 26 further comprising:
selecting the unique name saved in the selectable drop-down portfolio navigation tree; and
applying the search criterion corresponding to the unique name.

28. The user interface control system method of claim 19 wherein:
the inline and dynamic navigation dialogue box further comprises:
a tool bar to specify at least one action that can be performed on the plurality of nodes, wherein the plurality of nodes correspond to system objects, and wherein the at least one action corresponds to a relational criterion for acting on the system objects.

29. A computer user interface control system comprising:
means for displaying a navigation area, wherein the means for displaying a navigation area further comprises:
means for displaying available computer resources in a navigation tree comprised of one or more nodes;
means for displaying an inline control for selecting actions to be performed on the nodes of the navigation tree;
means for specifying a relational operation to be performed on one or more nodes of the navigation tree; and
means for displaying the result when the relational operation is applied to the one or more nodes of the navigation tree.

30. A computer system comprising:
a processor;
a memory coupled to the processor, wherein the memory stores a program of machine-readable instructions executable by the processor to perform operations to display a user interface control system, the operations comprising:
displaying an inline and dynamic navigation dialogue box, the inline and dynamic navigation dialogue box comprising:
a navigation tree region to display a selectable drop-down portfolio navigation tree comprised of a plurality of nodes;
a filter function to filter the plurality of nodes of the navigation tree; and
a search function to search the plurality of nodes of the navigation tree.

31. The computer system of claim 30 wherein the operations further comprise:
filtering the plurality of nodes using a filter specified using the filter function.

32. The computer system of claim 31 further comprising:
means for displaying the plurality of nodes in accordance with the filter criterion.

33. The computer system of claim 31 wherein:
the inline and dynamic navigation dialogue box further comprises:
a naming function to assign a unique name to filter criterion specified using the filter function; and
wherein the operations further comprise:
assigning a unique name to filter criterion using the naming function.

34. The computer system of claim 33 wherein:
the inline and dynamic navigation dialogue box further comprises:
a saving function to save the unique name assigned to filter criterion to the selectable drop-down portfolio navigation tree; and
wherein the operations further comprise:
saving the unique name to the selectable drop-down portfolio navigation tree.

35. The computer system of claim 34 wherein the operations further comprise:
selecting the unique name saved in the selectable drop-down portfolio navigation tree; and
applying the filter criterion corresponding to the unique name.

36. The computer system of claim 30 wherein the operations further comprise:
searching the plurality of nodes using a search specified using the search function.

37. The computer system of claim 36 wherein:
the inline and dynamic navigation dialogue box further comprises:
a naming function to assign a unique name to search criterion specified using the search function; and
wherein the operations further comprise:
assigning a unique name to search criterion using the naming function.

38. The computer system of claim 37 wherein:
the inline and dynamic navigation dialogue box further comprises:
a saving function to save the unique name assigned to search criterion to the selectable drop-down portfolio navigation tree; and
wherein the operations further comprise:
saving the unique name to the selectable drop-down portfolio navigation tree.

39. The computer system of claim 38 wherein the operations further comprise:
selecting the unique name saved in the selectable drop-down portfolio navigation tree; and
applying the search criterion corresponding to the unique name.
